(19) United States
(12) Patent Application Publication
(10) Pub. No.: US 2016/0299534 A1
(43) Pub. Date: Oct. 13, 2016

(54) ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: SHU-QI WU, Wuhan (CN); YONG-CHANG FAN, Wuhan (CN); YU-LIN LIU, Wuhan (CN)

(21) Appl. No.: 14/695,978

(22) Filed: Apr. 24, 2015

(30) Foreign Application Priority Data
Apr. 10, 2015 (CN) 201510166429.2

(51) Int. Cl. G06F 1/16

(52) U.S. Cl. CPC G06F 1/1656; G06F 1/1632

(57) ABSTRACT

Electronic device includes a main module, a sliding member, a resilient member, and an expansion module coupled to the main module. The main module includes a base, and the sliding member is slidably attached to the base. The resilient member is located between the sliding member and the base, and the expansion module includes a clipping member. The expansion module is moveable in a first direction to slide the sliding member in a second direction that is perpendicular to the first direction, and the resilient member is deformable to engage the sliding member with the clipping member.

### FIELD

The subject matter herein generally relates to an electronic device.

### BACKGROUND

Electronic devices, such as an All-In-One computer, can include a host and a display integrated with the host. Generally, the host can include a receiving space for receiving a plurality of electronic components such as a power supply module, a motherboard, a fan, and a storage device. For increasing the function of the host, an expansion module can be connected to the host by screws, and a plurality of peripheral components, such as a mouse, and an earphone, can be connected to the expansion module.

### BRIEF DESCRIPTION OF THE DRAWINGS

Implementations of the present technology will now be described, by way of example only, with reference to the attached figures.

FIG. 1 is an exploded, isometric view of an embodiment of an electronic device.

FIG. 2 is similar to FIG. 1, but viewed from a different angle.

FIG. 3 is an assembled view of a base, a sliding member and a resilient member of the electronic device of FIG. 1.

FIG. 4 is an assembled view of the electronic device of FIG. 1, and an expansion module is disengaged from a main module.

FIG. 5 is similar to FIG. 4, and the expansion module is engaged with the main module.

FIG. 6 is a cross-sectional view of FIG. 5, taken along a line VI-VI, and the sliding member is engaged with two clipping members of the expansion module.

FIG. 7 is similar to FIG. 6, and the sliding member is disengaged from the two clipping members of the expansion module.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an electronic device. The electronic device includes a main module, a sliding member, a resilient member, and an expansion module coupled to the main module. The main module includes a base, and the sliding member is slidably attached to the base. The resilient member is located between the sliding member and the base, and the expansion module includes a clipping member. The expansion module is moveable in a first direction to slide the sliding member in a second direction that is perpendicular to the first direction, and the resilient member is deformable to engage the sliding member with the clipping member.

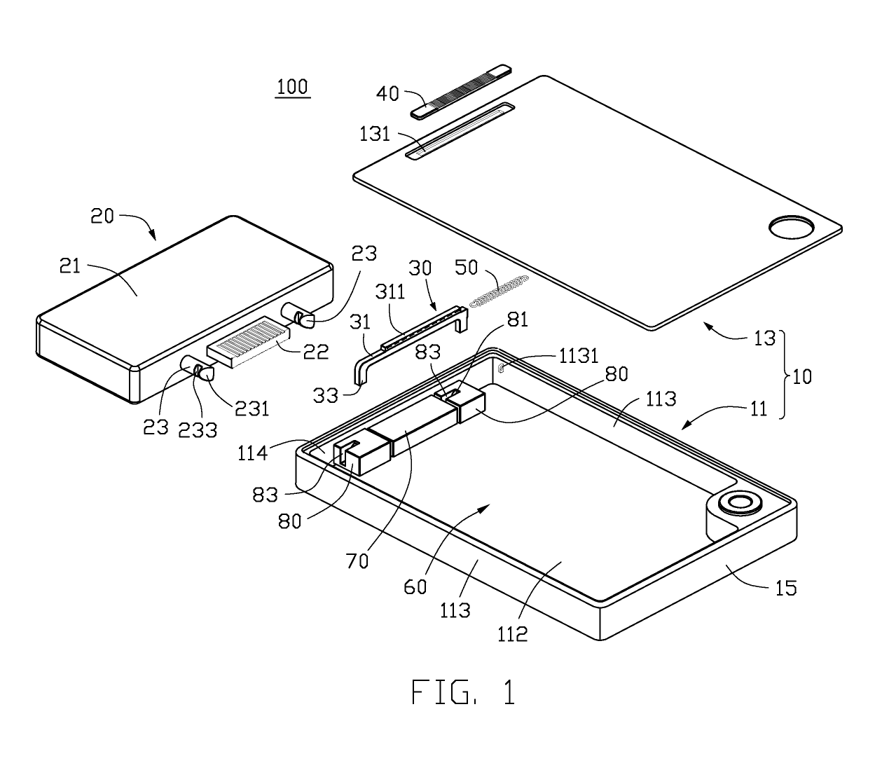

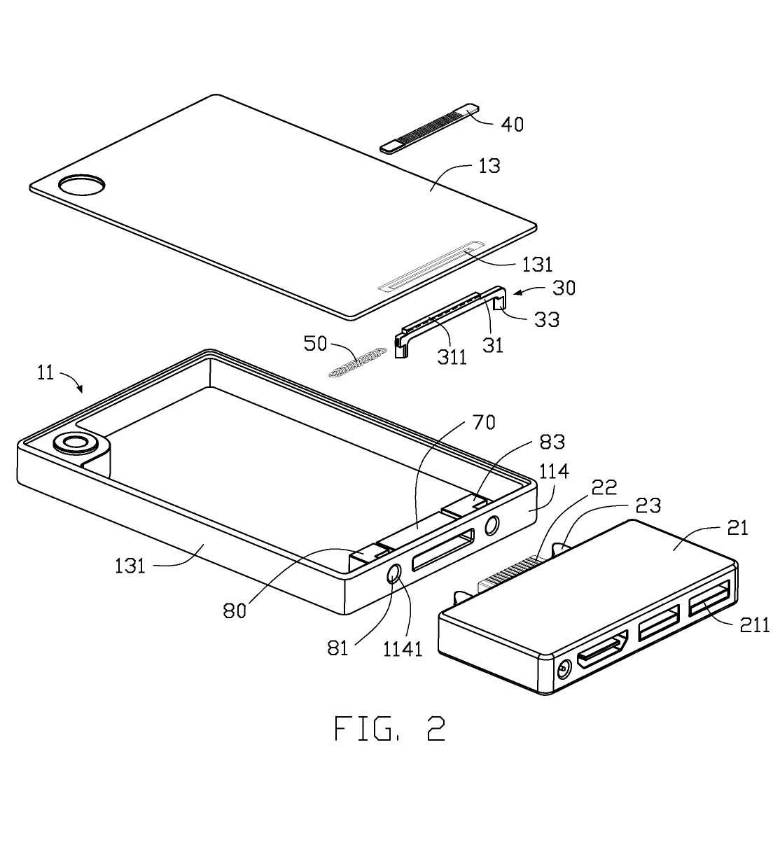

FIGS. 1-2 illustrate an embodiment of an electronic device 100. The electronic device 100 can include a main module 10, an expansion module 20 coupled to the main module 10, a sliding member 30 slidably attached to the main module 10, an operating member 40 attached to the sliding member 30, and a resilient member 50. In at least one embodiment, the main module 10 can be a host of an All-In-One computer which can include a plurality of electronic components (not shown), a power supply module, a motherboard, a fan, a storage device, and such, and the expansion module 20 can increase the function of the main module 10 and is configured to couple to a plurality of peripheral components, such as a mouse, or an earphone.

The main module 10 can include a base 11 and a top panel 13 attached to the base 11. The base 11 can include a bottom panel 112, two side panels 113 extending from opposite edges of the bottom panel 112, a front panel 114 coupled to the bottom panel 112 and the two side panels 113, and a rear panel 15 coupled to the bottom panel 112 and the two side panels 113. The bottom panel 112, the two side panels 113, the front panel 114, and the rear panel 15 cooperatively define a receiving space 60 for receiving the plurality of electronic components.

A socket 70 and two securing blocks 80 are located on the bottom panel 112 and are adjacent to the front panel 114. The two securing blocks 80 are located on opposite sides of the socket 70. Each securing block 80 defines an extending hole 81 and a sliding slot 83 communicating with the extending hole 81. In at least one embodiment, an extending direction of the extending hole 81 is substantially perpendicular to an extending direction of the sliding slot 83, for example, the extending direction of the extending hole 81 can be substantially perpendicular to the front panel 114, and the extending direction of the sliding slot 83 can be substantially parallel to the front panel 114. One of the two side panels 113 can include a first hook 1131, which can be configured to engage with a first end of the resilient member 50. Two through holes 1141 can be defined in the front panel 114, and each through hole 1141 communicates with each extending hole 81. A receiving slot 131 is defined in the top panel 13.

The expansion module 20 includes a main body 21, a plug 22 located on a rear portion of the main body 21, and two clipping members 23 located on opposite sides of the plug 22. A plurality of ports 211 is located on a front portion of the main body 21. Each clipping member 23 includes a slanted surface 231, and a clipping slot 233 is defined in each clipping member 23. The clipping members 23 can extend through the corresponding through holes 1141 and the extending hole 81 to be received in the sliding slot 83.

The sliding member 30 can include a cross bar 31 and two mounting portions 33 extending from opposite sides of the cross bar 31. In at least one embodiment, each mounting portion 33 is substantially perpendicular to the cross bar 31. An engaging portion 33 is located on the cross bar 31 and is configured to extend through the receiving slot 131 to engage with the operating member 40. A second hook 313 is located on one side of the cross bar 31 to clip with a second end of the resilient member 50.

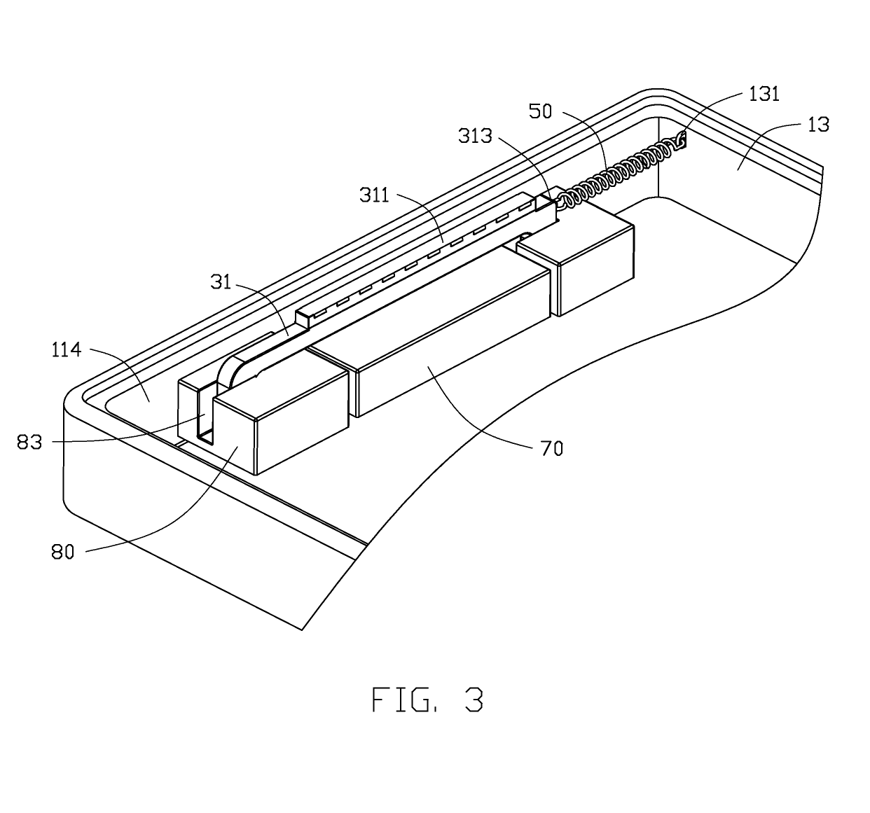

FIGS. 2 and 3 illustrate an embodiment of the base 11 with the sliding member 30 and the resilient member 40. In assembly, the sliding member 30 is placed on the plug 70, and the two mounting portions 33 are inserted into the two corresponding sliding slots 83. The first end of the resilient member 50 is engaged with the first hook 1131, and the second end of the resilient member 50 is engaged with the second hook 313. Thus, the resilient member 50 is located between the side panel 113 and the cross bar 31.

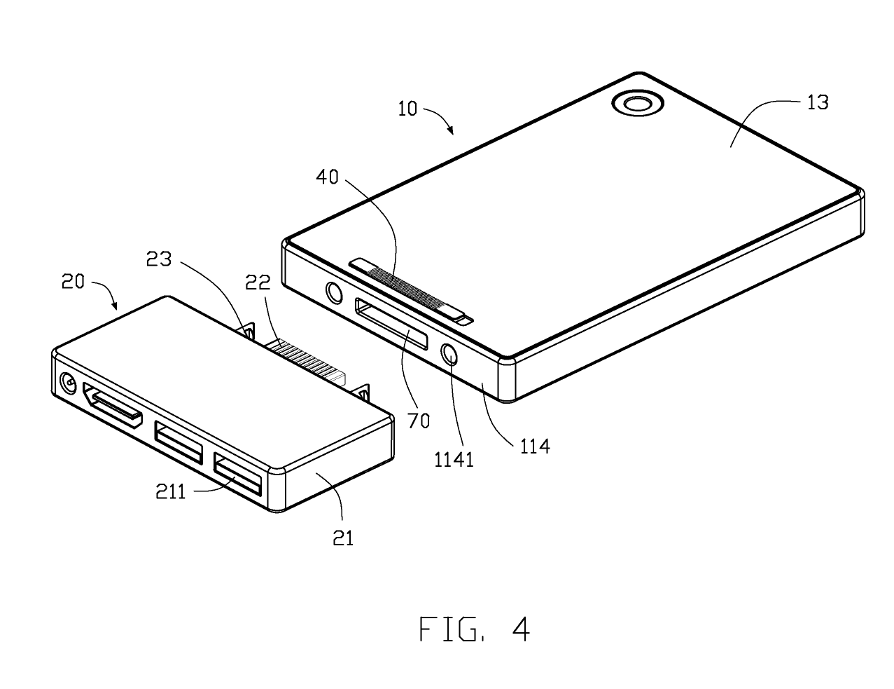

Referring to FIGS. 3 and 4, the top panel 13 is secured to the base 11 (see FIG. 2), and the engaging portion 311 extends through the receiving slot 131. The operating member 40 is secured to the engaging portion 311 by manners known in the art, such as jointing or paste.

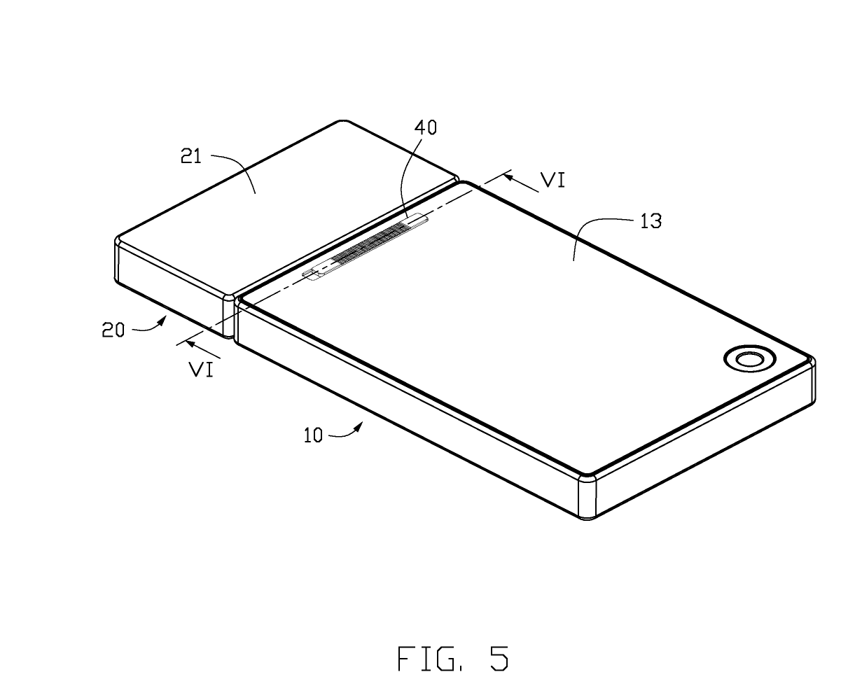

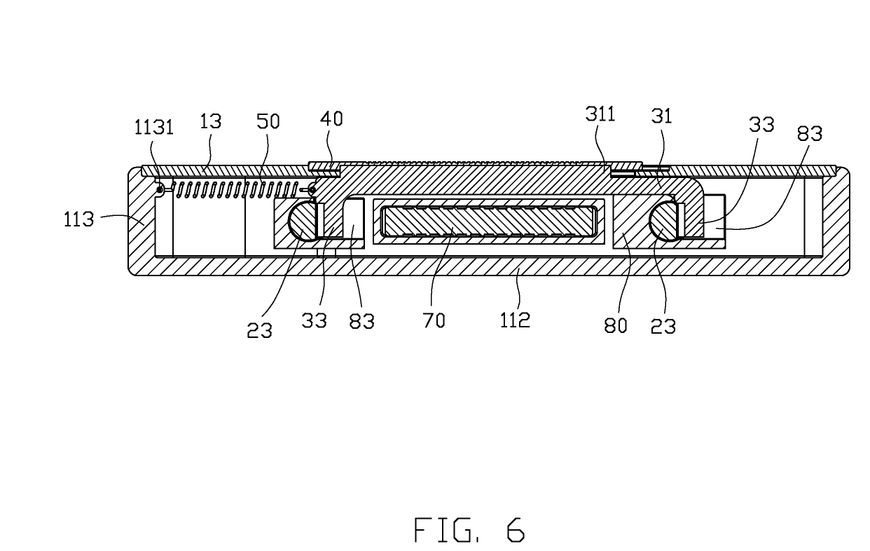

FIGS. 5 and 6 illustrate the expansion module 30 is engaged with the main module 10. In assembly, the expansion module 30 is moved in a first direction, for allowing the clipping members 23 to extend through the through holes 1141 and the extending holes 81 to be resisted on the mounting portions 33 of the sliding slot 83. The expansion module 30 is further moved, and the slanted surface 231 of each clipping member 23 urges the mountings portions 33 to slide the sliding member 30 in a second direction that is perpendicular to the first direction. The resilient member 50 is deformed, and the plug 22 is engaged with the plug 70. When the slanted surface 231 passes through the mounting portion 33, the resilient member 50 is released to pull the sliding member 30 in a third direction that is opposite to the second direction. Until the mounting portions 33 are engaged in the clipping slots 233, the expansion module 20 can be secured to the main module 10.

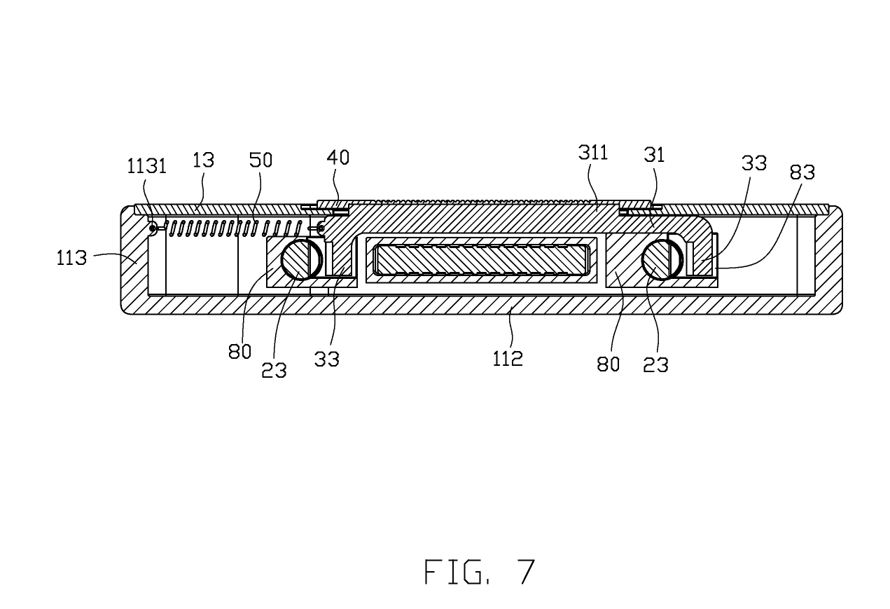

FIG. 7 illustrates the expansion module 30 is disengaged from the main module 10. In disassembly, the operating member 40 is operated to slide the sliding member 30 in the second direction, and the resilient member 50 is deformed to disengage the mounting portions 33 from the corresponding clipping slots 233. The expansion module 83 is pulled in a direction that is opposite to the first direction, so that the clipping members 23 can be disengaged from the corresponding sliding slots 83. The expansion module 83 is further pulled, and the clipping members 23 can be disengaged from the extending holes 81 and the through holes 1141. The plug 22 is detached from the socket 70, thus, the expansion module 20 can be removed from the main module 10.

The embodiments shown and described above are only examples. Many details are often found in the art such as the other features of a electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device comprising:
a main module comprising a base;
a sliding member slidably attached to the base;
a resilient member located between the sliding member and the base; and
an expansion module coupled to the main module; the expansion module comprising a clipping member;
wherein the expansion module is moveable in a first direction to slide the sliding member in a second direction that is perpendicular to the first direction, and the resilient member is deformable to engage the sliding member with the clipping member.

2. The electronic device of claim 1, wherein the clipping member comprises a slanted surface, and the slanted surface is configured to urge the sliding member to slide in the second direction.

3. The electronic device of claim 1, wherein the clipping member defines a clipping slot, and the sliding member comprises a mounting portion engaged in the clipping slot.

4. The electronic device of claim 3, wherein the sliding member further comprises a cross bar, and the mounting portion is substantially perpendicular to the cross bar.

5. The electronic device of claim 4, further comprising an operating member, wherein the operating member is attached to the cross bar and is configured to slide the sliding member.

6. The electronic device of claim 5, wherein the cross bar comprises an engaging portion, the main module further comprises a top panel, the top panel defines a receiving slot, and the engaging portion extends through the receiving slot to engage with the operating member.

7. The electronic device of claim 6, wherein a sliding slot is defined in the main module, and the mounting portion is slidably received in the sliding slot.

8. The electronic device of claim 7, wherein the base comprises a bottom panel substantially parallel to the top panel, a securing block is attached to the bottom panel, and the sliding slot is defined in the securing block.

9. The electronic device of claim 8, wherein the base comprises a side panel substantially perpendicular to the bottom panel, a first hook is located on the side panel to engage with a first end of the resilient member, and a second hook is located on the cross bar to engage with a second end of the resilient member.

10. The electronic device of claim 9, wherein the securing block defines an extending hole communicating with the sliding slot, a through hole is defined in the side panel aligned with the extending hole, and the clipping member extends through the through hole and the extending hole to locate in the sliding slot.

11. An electronic device comprising:
a main module comprising a base; the base comprising a front panel; a through hole defined in the front panel;
a sliding member slidably attached to the base;
an expansion module coupled to the main module; the expansion module comprising a clipping member;
wherein the clipping member extends through the through hole to engage with the sliding member.

12. The electronic device of claim 11, wherein the sliding member is slidable relative to the base in a direction that is substantially parallel to the front panel.

13. The electronic device of claim 11, wherein the clipping member comprises a slanted surface, and the slanted surface is configured to urge the sliding member to slide in the second direction.

14. The electronic device of claim 11, wherein the clipping member defines a clipping slot, and the sliding member comprises a mounting portion engaged in the clipping slot.

15. The electronic device of claim 14, wherein the base further comprises a bottom panel substantially perpendicular to the front panel, a securing block is attached to the bottom panel, a sliding slot is defined in the securing block, and the mounting portion is slidably received in the sliding slot.

16. The electronic device of claim 15, wherein the securing block defines an extending hole communicating with the sliding slot, the through hole is aligned with the extending hole, and the clipping member extends through the through hole and the extending hole to locate in the sliding slot.

17. The electronic device of claim 14, further comprising a resilient member, wherein the sliding member further comprises a cross bar, a first hook is located on the side panel to engage with a first end of the resilient member, and a second hook is located on the cross bar to engage with a second end of the resilient member.

18. The electronic device of claim 17, further comprising an operating member, wherein the operating member is attached to the cross bar and is configured to slide the sliding member.

19. The electronic device of claim 18, wherein the cross bar comprises an engaging portion, the main module further comprises a top panel, the top panel defines a receiving slot, and the engaging portion extends through the receiving slot to engage with the operating member.

20. An electronic device comprising:
a main module having a receiving space;
an expansion module engagable with the main module and comprising a clipping member; and
a sliding member selectively movable relative to the main module; and
a resilient member coupled to the sliding member and deformable allowing the sliding member to move from a locking position to a open position;
wherein, the sliding member is moved into the open position, deforming the resilient member, as the clipping member are inserted into the receiving space; and
wherein, when the clipping member are substantially fully inserted into the receiving space, the resilient member moves the sliding member back to the locking position.
